(19) United States
(12) Patent Application Publication
(10) Pub. No.: US 2010/0123779 A1
(43) Pub. Date: May 20, 2010

(54) Video recording system for a vehicle

(76) Inventors: Dennis Michael Snyder, Indianapolis, IN (US); Michael Bret Richardson, Noblesville, IN (US); Brandon Robert Giger, Carmel, IN (US)

Correspondence Address: INDIANO VAUGHAN LLP, SUITE 1300, ONE NORTH PENNSYLVANIA STREET, INDIANAPOLIS, IN, 46204, US

(21) Appl. No.: 12/313,182

(22) Filed: Nov. 18, 2008

(51) Int. Cl. H04N 7/18; H04N 7/26

(52) U.S. Cl. 348/148; 386/124; 386/E05.001; 348/E07.085

(57) ABSTRACT

A video recording device is capable of being mounted in a vehicle for recording images incident to the operation of the vehicle. The video recording device includes a housing mountable to a vehicle component, and at least image sensor for capturing images. A processor is coupled to the housing and is in communication with the image sensor, for processing images captured by the image sensor. An event detector is provided for detecting the existence of a designated event (such as a crash). A long term memory device is provided for storing images captured by the at least one image sensor for a time period prior to, and for a time period following the detection of a designated event by the event detector.

### I. TECHNICAL FIELD OF THE INVENTION

The present invention relates to a video recording device, and more particularly, to a video recording device that is particularly useful in recording the events attendant to the operation of a motor vehicle, and in particular, is particularly well adapted to recording accident or crash events that occur during the operation of an automotive vehicle.

### II. BACKGROUND OF THE INVENTION

Automotive accidents have occurred since shortly after the introduction of the automobile. Due to the nature of the operation of motor vehicles, the involvement of a vehicle in an accident can result in the imposition of liability, costs and damages on a party operating the vehicle who is found by a court to be negligent or reckless in the operation of their vehicle. If two vehicles are involved, there often exists a substantial question as to which of the drivers was the negligent party, and therefore which of the drivers should be held liable for the imposition of damages for any injuries or property damage that occur.

This imposition of liability is particularly acute with vehicles that travel a large number of miles, (such as trucks) because the large number of miles increases the likelihood of the vehicle being in an accident. The imposition of liability is also a problem with vehicles that carry passengers for hire, such as limousines and cabs. Because of the potential for liability, it is believed that it would be helpful to have a recording device that records the operation of the vehicle, so that, especially in an accident situation, a record would be made of the accident to better help determine liability attendant to the accident. Additionally, it is believed that recording the operation of a vehicle can lead to a reduction in accidents, and increase safety when operating a vehicle, due to the fact that drivers who know that their actions are being recorded are less likely to drive negligently.

To this end, several devices have been invented that are useable to record the operation of a vehicle. For example, several patents exist that list Gary A. Raynor as an inventor, including U.S. Pat. Nos. 6,389,340, that relates to a vehicle data recorder. Other Raynor patents include U.S. Pat. Nos. 6,449,540; 6,718,239; and 6,405,112.

Although known patents and devices in many cases are capable of performing their function in a workman-like manner, room for improvement exists. One disadvantage of known prior art systems is the termination of recording at the time when an accident event occurs. It is easy to imagine a scenario where continued recording, even for a matter of seconds, would improve the ability of the device to provide useful information to a user. One such scenario is where the device is user actuated in response to a robbery. Additionally, images shot after an accident may prove vital in showing the extent of injuries (or lack thereof) directly after an accident event, to thereby help to reduce fraudulent injury claims or misrepresentation.

Finally, another advantage of the present invention is that it is easily interfaceable with a home computer, thereby obviating the need for purchasing or maintaining specialized equipment for viewing the recordings.

### III. SUMMARY OF THE INVENTION

In accordance with the present invention, a video recording device is provided that is capable of being mounted to a vehicle for recording images incident to the operation of the vehicle. The video recording device comprises a housing mountable to a vehicle component, and at least one image sensor for capturing images. The process is coupled to the housing and is in communication with the image sensor, for processing images captured by the image sensor. An event detector is provided for detecting the existence of a designated event. A long term memory device is provided for storing images captured by the at least one image sensor for a time period prior to, and following the detection of a designated event by the event detector.

A receiver can be provided for receiving images from a third image to sensor that can be disposed remotely of the housing, such as being disposed on the exterior of the vehicle. The device of the present invention is both user and event controlled. If the user begins recording in the vehicle, or if a designated event occurs, the data stored in the volatile memory will be stored in a long term memory component.

One feature of the present invention is that a preferred embodiment of the present invention includes inputs that allow the recording system to be connected to external data sensors already installed in the vehicle so that the data from those sensors can be added to the data acquired by the recording system. The device has the ability to automatically adjust to incorporate a third camera input and to properly record the signals from the third camera in synchronization with the first and second cameras.

Another feature of a preferred embodiment of the present invention is the removable nature of the non volatile memory component. Once removed, the non volatile memory has been designed to be coupled to, and completely compatible with any personal computer so that information from the non-volatile memory can be transferred to the personal computer, or perhaps a PDA. Alternately, a port, such as a USB Port can be provided so that data stored on the device can be downloaded to an external flash memory device, that can then be coupled to a computer, so that the data can be uploaded on the computer. Alternately, the port can be coupled to a wireless transmitter for wireless transmission of data between the device and a computer. Another option is to employ an internal wireless transmission device, for enabling wireless communication. Such a wireless device can be functionally similar to an internal wireless card of a notebook computer, or a blue-tooth type wireless transmitter of the type employed on telephone PDAs, such as the Palm®Treo® 700. Individual user configurations can also be stored in the removable media, allowing the user to insert a customer configured media card at the time the vehicle will be used.

These and other features of the present invention will become apparent to those skilled in the art by reviewing the drawings and detailed description presented below, which present the best mode of practicing the invention perceived presently by the Applicant.

### IV. BRIEF DESCRIPTION OF DRAWINGS

FIG. 1A is a schematic view of the major components of the present invention;

FIG. 1B is a schematic view of the major components of the present invention in the housing;

FIG. 1C is a front view of a mount usable with the device of the present invention;

FIG. 1D is a side view of a bracket member of the Mount shown in FIG. 1C;

FIG. 2 is a more detailed schematic view of the hardware of the present invention;

FIG. 3 is a schematic view of the software operation of the present invention;

FIG. 4 is a schematic view of the software operation of the present invention;

FIG. 5A is a frontal, somewhat schematic view showing the exterior of the casing of the device from the rearwardly facing side of the device; and

FIG. 5B is an elevational view of the forwardly facing side of the external housing of the device.

### V. DETAILED DESCRIPTION

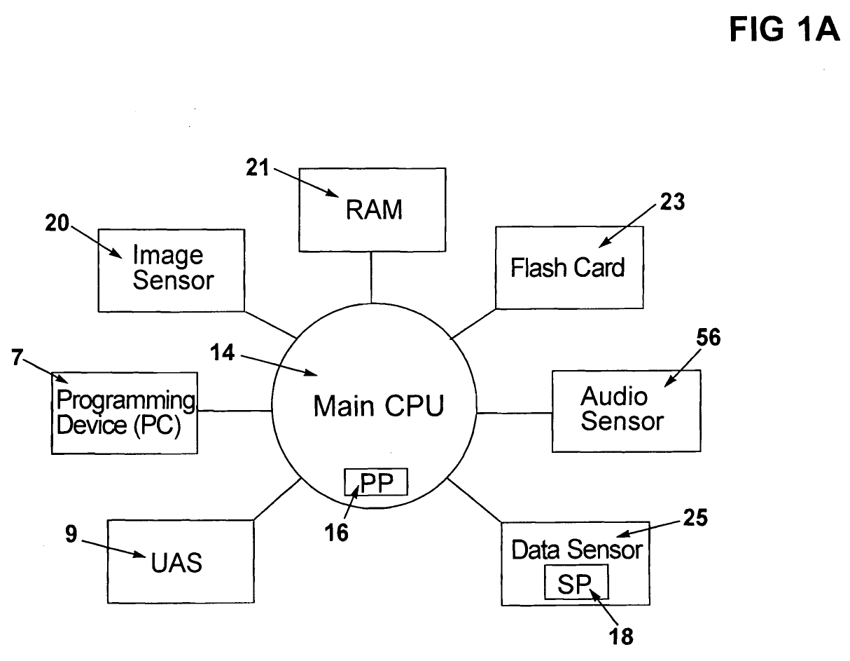

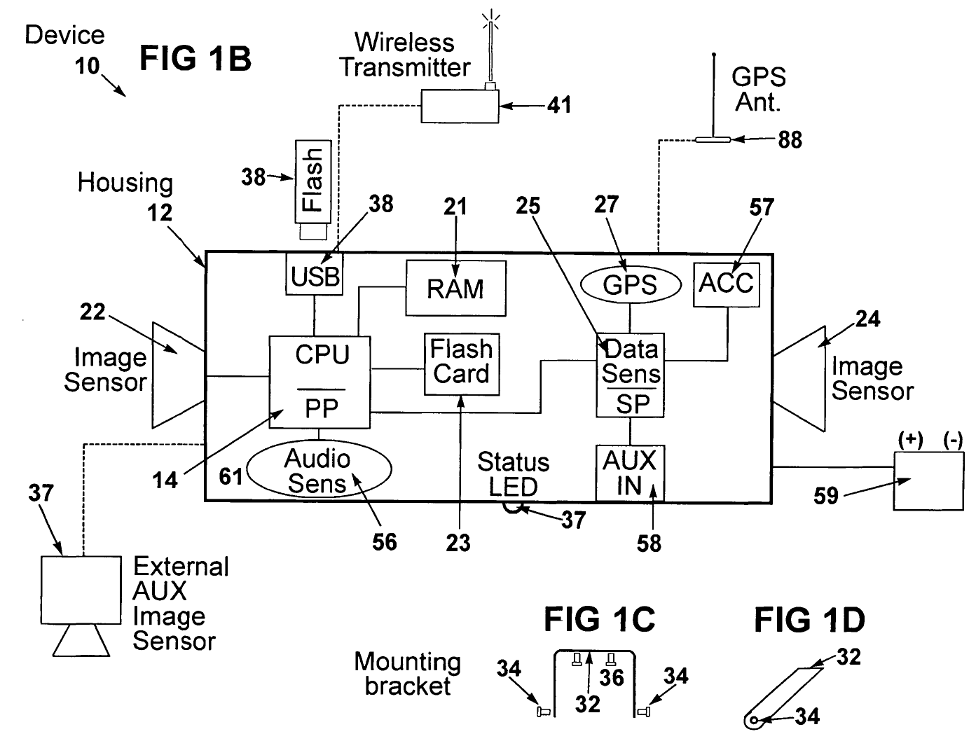

As best shown in FIGS. 1A and 1B, a video recording system 10 is designed to be mounted on the interior of a vehicle. The recording system 10 includes a housing 12 that houses most or all of the primary electronic components that collectively comprise the recording system 10. The design of the housing 12 can be modified to both provide room for inclusion of the various components, and to fit into a variety of models of vehicles, and a variety of positions inside of vehicles. Although the recoding system 10 can be used in any sort of vehicle (including vehicles such as boats and aircraft), it is believed that the primary market for the device 10 will be in passenger-carrying commercial vehicles such as cabs, limousines and busses; and other commercial vehicle such as trucks.

The primary components of the system 10 include a CPU 14 containing a primary processor 16, and a secondary processor 18. A video camera system 20 is included that contains at least one image sensor comprising a video camera, and a video decoder 22. As best shown in FIG. 1B, the image sensor 20 preferably comprises a first 22 and a second 24 video camera. A third camera 37 can be connected through AUX inputs 58 or USB port 38, as desired. Additional signal inputs, such as turn signal, brake light or other vehicle devices can be coupled to AUX inputs 58 to allow the device to record the signal for playback.

The device 10 includes a data sensor 25 that preferably includes a plurality of components for sensing different types of data, for providing several input streams of information to the device 10. These components preferably include a global positioning system (GPS) sensor 27 that provides a stream of geographic position data to the device 10. An audio sensor 56 provides a stream of audio and sound information, and an accelerometer 57 provides a stream of acceleration information. Acceleration (change in velocity) information is important information for the operation of the device, since a rapid decrease or increase in velocity can signal the presence of a crash event of the type that the device 10 is particularly useful for recording. The data sensor 25 can also be a speed measuring device, which operates either through the vehicle's speedometer, or the GPS to determine the vehicle speed, and to trigger a designated event if the vehicle exceeds a predetermined speed. In addition to the data sensor 25, a user actuable switch (UAS) 9 can be coupled to the CPU 14, to enable the user to actuate the UAS 9 to cause the CPU to begin capturing and storing data from a designated event. For example, the UAS 9 can comprise a foot switch that can be actuated by a user's foot in the event of a robbery or health emergency, so that in such event, storage of images would occur. Optionally, the device can also be designed so that actuation of the UAS 9 causes the device to send a signal to an appropriate agency or organization such as a police department or alarm monitoring company.

A short term memory device that preferably comprises a RAM type memory 21 and a long term memory device, that preferably comprises a flash memory device, (commonly referred to as a flash card). Flash memories (flash cards) currently exist in a wide variety of types and formats. Among the most popular types are SD (secure digital) cards, mini SD cards, micro SD cards, High Capacity SD Cards (SDHC cards), compact flash (CF) cards, USB Flash drives, memory sticks and XD memory cards. During operation of the vehicle, the recording system 10 is electrically powered by electrical power supplied by the vehicle and its battery 59, or else by a special battery (not shown) that may be disposed within the housing 12. A battery is preferably disposed within the housing to serve as a back up, in case the vehicle's battery fails.

The device 10 may also include a programming device 7. The programming device can comprise a series of buttons or keyboard contained on the device 10 itself, or connectable to the device via, for example, a USB port, connector and wire. However, the programming device 7 is preferably a separate or separable programming device that is not normally coupled to the device 10. For example, the programming device 7 can comprise a computer having a card reader. Software can be provided for running on the computer for enabling the user to program information into the flash memory 23, so that the information so programmed onto the flash card 23 will help direct the operation of the device and the CPU 14.

Preferably, several of the operational parameters of the device are variable by the user, so that the operation of the device can best address the user's desires. For example, variable parameters include such things as (a) defining a “designated event” parameter; (b) time related parameters; (c) frame rate parameters; (d) space parameters; (e) accelerometer parameters; (f) image recording parameters; and (g) event tagging (amount of G-Force imposed) parameters.

Preferably, the parameter setting software should include auto adjusting, user configuration menus. These menus will enable the user to automatically see the affect that a change of one parameter has on the operational parameter. For example, for a device having a flash memory 23 of a given capacity (e.g. 2 GB), the user's decision to increase the frame rate will reduce the amount of time during which the user can capture data. The auto adjusting user configuration menus would automatically adjust the affected operational parameters to reflect the user changed operational parameters.

The programming device 7 preferably programs the flash memory 23 when the flash memory 23 is inserted into the programming device's 7 card reader, so that when the flash memory 23 is removed from the card reader of the programming device 7 and then inserted into the recording device 10, the instructions programmed into the flash card 23 will direct the operation of the device 10.

When the vehicle is operating and the system 10 is operational, the video cameras 22, 24 and other data sensors 25, 26, 27, 57 constantly capture images and other data. The captured data is then converted to digital signals by decoders and sent to the CPU 14. When the data reaches the CPU 14, it is temporarily stored in the short term RAM memory 21. The RAM will usually continue to accept new information until it becomes filled to capacity with information. At that point, the previously stored information on the RAM is preferably overwritten with newly acquired data.

When a designated event is detected by one or more of the data sensors 25, and reported to the CPU 14, data that has been acquired prior to the designated event, and which remains stored on the RAM 21, along with data acquired for some time after the designated event, are copied from the RAM 21, to the long term flash memory 23, or, alternately, are transferred directly to the flash card 23 from the CPU 14. During memory transfer, the flash card 23, the data sensor 25 and the image sensor 20 continue to acquire information and the RAM 21 continues temporarily storing the data and images acquired from the data 25 and image 20 sensors.

As will be described in more detail below, the device 10 continues to operate in a manner wherein it captures image information, and captures other data information, such as acceleration data, GPS data and auditory data. This acquisition of data (including image data) continues on until a “designated event” occurs. A designated event is an event for which the user or the designer of the machine has designated the machine to respond, in a manner that causes a change in the operation of the device. For example, a designated event can be a crash-type of an event. In a typical crash type of an event, data forwarded from the accelerometer 57 to the data sensor 25 would show that an abnormally rapid decrease in velocity has occurred in the device 10. This rapid decrease in velocity is the type of rapid decrease that one would expect if the vehicle were engaged in a crash, such as if it crashed into the rear of the vehicle ahead of it.

The user and programmer may use such a designated event, to cause the change in the operation of the device, such as causing the device to go into a data retention mode type of operation, wherein the device would store data within the non volatile flash card-type memory 23. The data that is stored preferably includes data that was being stored in the RAM and that was acquired just prior to the designated event, and also data that is acquired for some period of time after the designated event. Such data could be continued to be acquired until such time as the user either manually ceases the termination of data acquisition storage, or else, the memory, such as the flash memory runs out of space, or otherwise, if the device shuts down.

Of course, the nature of the designated event that could be used to change the operation, and the nature of the operation so changed could vary widely depending upon the desires of the designers and users of the product. For example, the user could set event designations to the global positioning system so that a designated event would be deemed to occur when the device (or more particularly, the vehicle in which the device resided) was in a particular geographic area. For example, if the device 10 were used in connection with a truck that was suppose to travel over a designated route, a deviation from the designated route could be categorized as a designating event. This designation would cause captured information to be stored onto the long term memory so that, for example, the fleet manager of the vehicle that went off its designated path could keep tabs on unapproved activities by fleet vehicle drivers. Additionally, the device could be programmed for intermittent recording, so that images were captured from an image sensor(s), even in the absence of a designated event, on a regular internal (e.g. once every five seconds). This intermittent recording would yield a history of where the device had traveled during both those time periods outside of a designated event window, and on days when no designated event occurred. An external GPS antenna can be connected to the GPS antenna Jack 88 when increased GPS signal reception is desirable.

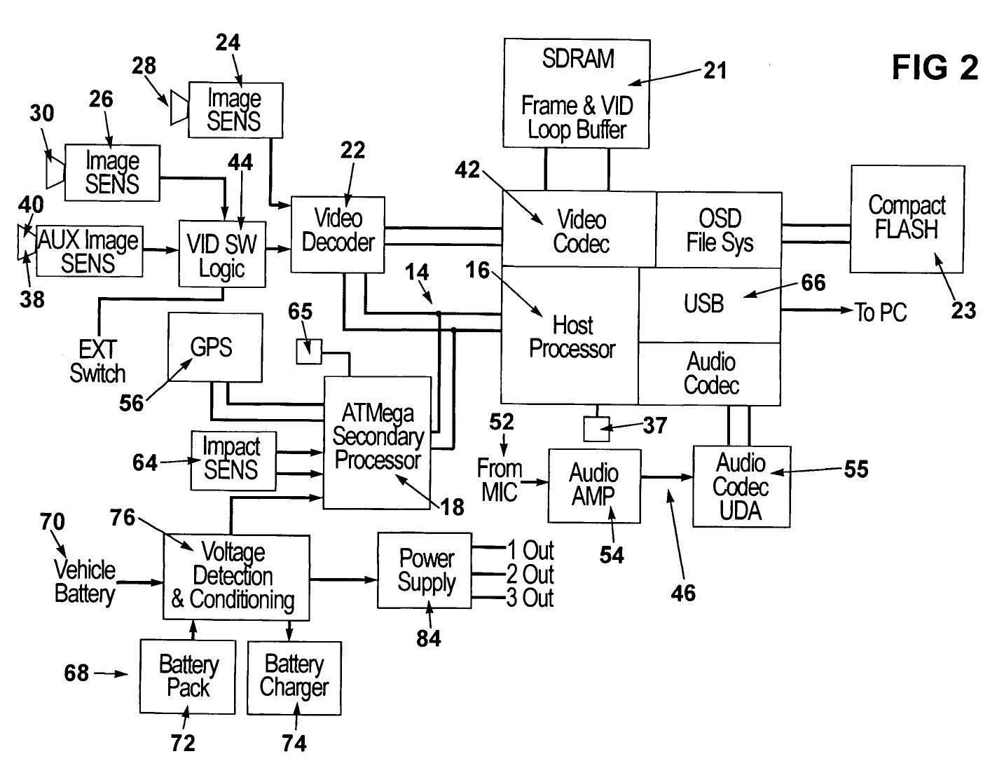

The video cameras 22, 24, 37 preferably use a complimentary metal oxide (C-MOS) or charged coupled device (CCD) imaging system. The cameras 22, 24 are initially disposed 180 degrees apart, so that one camera 24 is disposed to face, and capture images from the rear of the interior of the vehicle. Camera 22 faces forward to capture images of the area in front of the vehicle. The rearwardly facing camera 24 can be aimed to capture images of one or both of the exterior of the vehicle behind the vehicle, or the interior of the vehicle behind the front windshield. For example, the rearwardly facing camera 24 can be pointed at the driver and/or the passengers inside the vehicle while camera 22 faces forward to capture images of the area in front of the vehicle. The layout of the cameras allows the recording system 10 to record both internal and external occurrences proximate to a designated event. Each camera 22, 24 includes a lens 28, 30 (FIG. 2). In most embodiments, the lenses 28, 30 are preferably relatively wide angle lens, such as a 3.6 mm lens, to provide the greatest field of vision. The third exterior camera 37 input will capture video data, preferably when the vehicle is backing up. The configuration interface allows for the selection of operational parameters of the third camera 37 if it is used.

An adjustable mount 32 is provided for coupling the housing 12 to a vehicle. The adjustable mount 32 enables the housing, and hence the cameras 22, 24 to be adjustably positioned vis-à-vis the vehicle, to enable the user to orient the housing 12 and cameras 22, 24 in a desired direction(s). The adjustable mount 32 allows the user to adjust the position the axis of the lens over a range of up to 120 degrees. The adjustable mount 32 provides a set screw system 34 for maintaining the user's desired camera 22, 24 position so that the position can be fixed once it is adjusted to the proper position.

In addition to the camera mount 32, the housing 12 includes mounting hardware 36. The housing mounting hardware 36 further increases the adjustability of the system, and can be employed for mounting the housing 12 on the ceiling, the dashboard, the windshield glass, and/or the head liner of the vehicle. The housing 12 can further incorporate an LED display 37 for flashing an image or instruction or information to the user. Alternately, the display 37 can alert the user of the status of the vehicle recording system 10 by simply turning on and turning off.

The device 10 includes a USB input to connect the device 10 to a standard data storage device such as an external memory, such as flash memory drive 39, so that information stored on the device can be off-loaded to be stored on the data storage device 39 or its media. The third input 38 may also be used to connect accessory devices such as a wireless data transmitter 41. Such a wireless data transmitter 41 can be employed to facilitate the wireless transfer of data between the device 10 and the manager's computer. This wireless data transfer can be accomplished through a wide variety of technologies that are known now, and which may be invented in the future such as WIMAX, BLUETOOTH, Wi-Fi, UWB (Ultra Wide Band) and USB.

An external camera 37 can be connected to the device 10 through a camera input 61. In one embodiment, a rearview camera 40 (FIG. 2) is installed on to the rear of the vehicle, and is signaled from a source such as the backup lights or tail lights of the vehicle. This embodiment is capable of automatically switching from one of the internal cameras 24, 26 that are housed on the housing 12 to the external rearview camera 40.

In order to render the images from the video camera system 18, the analog signal captured by the cameras must be sent to the video decoder 22 (FIG. 2), to be converted from an analog to a digital signal capable of being read and manipulated by the CPU 14. Once the signal has been converted into a digital signal, the signal is sent to the hardware jpg codec 42.

At any one time, the video recording system 10 can capture and store images from at least two of the three inputs. A video input logic switch 44 controls which of the other two inputs is used. The video input logic switch 44 is coupled to the camera 26 and the external input 38. The video logic switch 44 contains solid state switches to route the desired input to the decoder 42. An input of 0 volts indicates that camera 26 is being used, and an input of 12 volts indicates the external input 38 is in use.

The video recording system 10 is designed to incorporate simultaneous audio capture, via an audio capture system 46 that includes an audio sensor 56. The audio capture system 46 includes a hardware audio codec device 48, which performs a similar function to the video codec by converting the analog audio signal picked up by the audio sensor into a digital signal capable of being read by the CPU 14.

The audio capture system 46 also includes a microphone input 50 and, in some embodiments, a built in microphone 52. The microphone 52 feeds the signal it picks up and generates into an audio amplifier 54. An audio codec 55 converts the captured audio signal to a useable digital signal. The audio capture system 46 provides an additional indicator as to the cause of a designated event and the existence and conditions of the factors that occurred near the time of the designated event, and which may have been factors in the designated event. For example, the audio capture system can record screeching tires, screams, and other sounds associated with a crash type designated event. Additionally, due to the constant operation of Applicant's invention, wherein data signals are being captured on a constant, ongoing basis, the audio system 46 has the capability to pick up cell phone conversations, in person conversations, loud radio sounds and other indicators of driver and passenger behavior within the vehicle.

The GPS receiver 56 is a self contained module. It includes an RF base receiver 58, a built in processor 60, and a built in antenna 62. The GPS system receives RF data from two or more of the 31 orbiting GPS satellites that orbit the earth at a distance of about 20,200 km. The satellites send out data that is received by the base unit and is converted into ascii strains. The ascii strains are then sent to the secondary processor. The GPS receiver sends longitude and latitude coordinates and the vehicle's direction of movement to the CPU from the reference point of the last registered coordinates. The GPS receiver can embed geographic position information into the data recorded by the camera, so that one playing back the data recorded by the camera will have geographic information about the place at which the event was recorded. Optionally, the embedded geographic information obtained by the GPS can be linked to a mapping program such as Google Earth to provide the viewer with map or satellite imaging of the place where the designated event occurred.

The vehicle recording system 10 includes an impact sensor 64 that preferably comprises a two axis accelerometer 64 (FIG. 2). Preferably, the accelerometer 64 has a detection trigger of +/−5 G forces in either direction, although the impact sensor 64 is user programmable to enable the user to require a greater or lesser amount of g forces to actuate the detection trigger. The programmability of the impact sensor 64 provides a fleet manager with the ability to record a sudden stop and allows the device 10 to be used to evaluate contract and employed drivers.

The impact sensor 64 provides the default determination of whether a designated event has occurred. The occurrence of a designated event causes the device 10 to copy the contents of the short-term RAM memory 21 to the longer-term flash memory 23 or alternately directly to the flash memory. In addition to the data sensors mentioned above, Applicant foresees incorporation of other data sensors into the design of the present invention based upon the needs of the user or operator of the vehicle.

Data storage transfer from short term memory 21 to long term flash memory 23 (or other long term memory) can be user actuated in addition to controlled by data sensors. A button or switch 65 is disposed on the recording system 10. When button 65 is pressed, the recording system 10 recognizes a designated event and thereby causes the device to enter its storage sequence 82 wherein recorded data is transferred to thereby long term memory 23 from the short term memory 21 and/or acquired data is directly written from the data acquisition devices on to the flash memory 23.

After the analog signal has been converted into digital signal, it is transferred to the CPU 14. The CPU 14 preferably contains a primary processor 16 and a secondary processor 18. The primary processor 16 is typically a sixteen bit RISC processor, and the secondary processor 18 is typically an eight bit RISC processor. The recording system 10 is designed so the primary processor 26 controls the video sensors and the secondary processor 18 controls all other data capture. The secondary processor 18 is constantly buffering the audio, GPS, and accelerometer data. When a designated event is recognized, the primary processor 16 will request and receive data from the secondary processor 18 and begin storage in the non volatile memory 23.

Both the volatile memory 21 and the non volatile memory 23 are coupled to the CPU 14. The digital signals representing the images are initially stored in the volatile random access memory (RAM) 21. The memory circuit sequences the data so the digital signals are stored in designated locations and then overwritten at some point in time, such as when the RAM 21 becomes full.

The non volatile memory 23 preferably comprises a flash memory device coupled to the CPU 14 via a connector port 65. Alternatively, the non volatile memory 23 can comprise other types of long term memory storage devices, such as a hard drive, tape, optical disk or other memory device invented in the future. The non volatile memory 23 itself is similar to an SD card memory stick or other off-the-shelf compact flash card. The non volatile memory 23 includes a USB connector 66 or other method of interfacing with a home computer.

The vehicle recording system 10 is preferably powered by the electrical system of the vehicle, although the device can carry its own on-board battery unit, or on-board back up power battery unit. A cable 70 is provided for connecting the recording system 10 to the electrical system of the vehicle. It is envisioned the vehicle's electrical system shall be the primary power source for the device 10 in most situations. In the event power is lost in the vehicle, the battery back up 68 contained within the housing 12 will continue the operation of the recording system 10.

In some instances, an automotive accident can disable the electronic system of the vehicle. Unfortunately, the occasions where the vehicle power system is disabled are situations where the recordings generated by the recording device 10 of the present invention are most useful. As such, a battery back up system 68 is a very desirable feature to include as part of the vehicle recording system 10. The battery back up system 68 includes a battery 72. The battery 72 preferably has a sufficient voltage to drive the recording system 10. The preferred embodiment includes a 7.2 volt battery. The battery preferably comprises a rechargeable battery pack, such as a nickel metal hydride battery pack. The battery back up system 68 also includes a charger circuit 74 that contains a voltage monitor 76 to monitor the voltage entering the system 10 and control the operation of the battery back up 68. The battery back up system 68 and the powering of the device are both controlled by the secondary processor 18 of CPU 14.

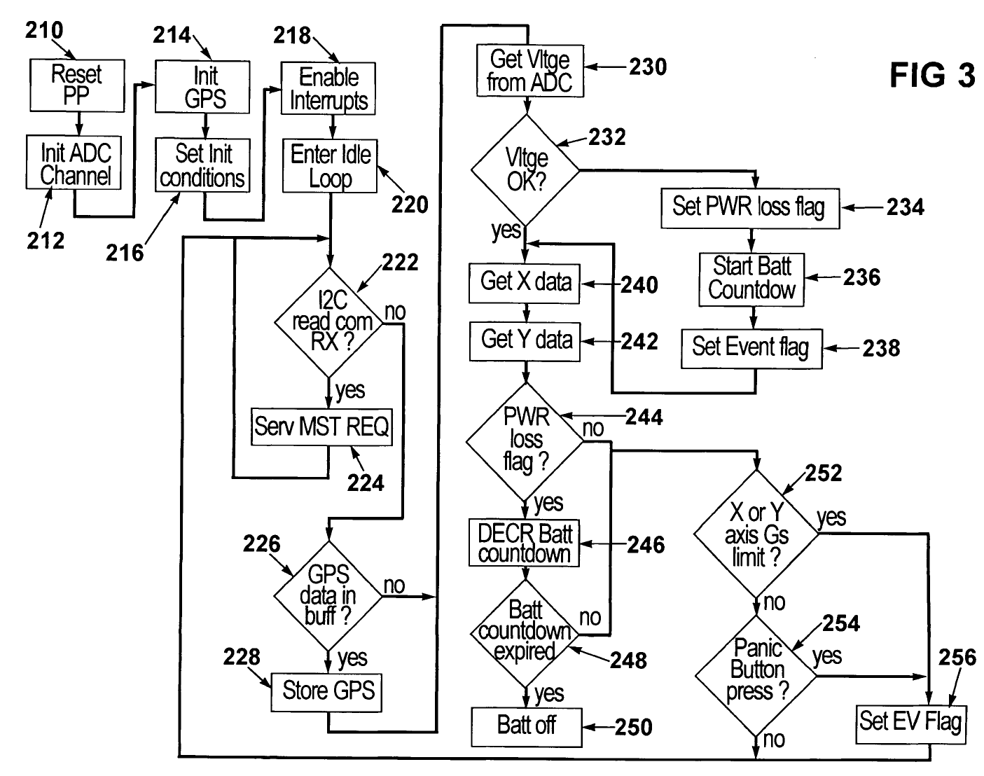

The flowchart of the operation software for the device is shown in FIG. 3. When the vehicle recording system 10 is powered up, the operational software cycles through a series of checks. First, the device 10 checks for USB and Flash memory 23 connectivity. If a USB connection is detected, the operational software will cause the device to enter playback mode. If there is no USB connectivity, the software will enter the device 10 into recording mode. The compact flash (CF) card check is performed upon entering recording mode.

The device configuration file 80 is stored in the non volatile memory 23. The configuration file contains all the recording parameters of the device, the frame rate, the length of the recording loop, and the threshold for G forces to determine whether a designated event has occurred. The configuration file contains all the settings for the recording parameters of the device. If the user or operator wants to record when the vehicle is subject to an extremely high or low force, the accelerometer device will store data in the configuration file as the accelerometer data relates to velocity changes, and hence changes in “G force” experienced by the device.

The configuration file 80 is capable of user modification at any computer. If no configuration file is custom-created by the use, a default configuration file 84 is preloaded into memory, containing all the default settings, including the accelerometer threshold, frame rate, GPS controls, and record time. The configuration file 80 can be configured multiple times to reflect different driving conditions or other environmental variables. After the configuration file 80 is loaded, the electronics are initiated, including the CPU 14, the video decoder 22, and the volatile memory 21.

The device 10 enters its idle loop 86 once the configuration file 80 is loaded and the electronics are initiated or booted up. The idle loop 86 is the primary operating environment of the vehicle recording system 10. During the idle loop 86, data is captured from all the data sensors continuously. The idle loop 86 is interspersed with interrupts, actions that temporarily suspend the idle loop and cause the device to perform a function, such as storing an image or other data into memory. Common interrupts include the end of a video frame, vertical synchronizations of the video decoder, and other data request from the individual components of the device 10.

The video captured by the cameras 24, 26 is interlaced video, where each picture comprises two fields, an even field 88 and an odd field 90. During image capture, the even field 88 is captured, followed by the odd field 90. During the capture of the odd field 90, the device interrupts are enabled and storage of all digital signals begins. Additionally, during the capture of the odd field 90, the device 10 begins computing the location of the subsequent frame. When the odd field 90 and the even field 88 have been captured, the frame must be compressed.

The audio, accelerometer, and GPS data are initially stored separately from the video frames. The CPU 14 creates an on screen display (OSD) overlay 94 with the non visual data. During compression, the OSD overlay 94 is sent and compressed with the frame, creating one bitmap file for the entire frame. The device then stores the frame in its short term memory 21.

The secondary processor 18 will set an event flag when a designated event has occurred, such as by some triggering event condition having been met. The primary processor 16 regularly communicates with the secondary processor 18 to determine whether an event flag has been set, signaling that long term storage is to begin. There are two types of event flags: a power loss flag and a triggering flag. A power loss flag signals that the device 10 is not receiving enough voltage from the power supply circuit. A triggering flag signals that conditions for a designated event have been met.

After a designated event has been signaled, recorded, and stored, an event folder is created within the long term memory 23. A windows compatible extension is created along with the event folder. In the preferred embodiment, this extension is a AVI format, but the device could be designed to use any format supported by Windows Media Player or other video playback software. Preferably, a unique, customized video, audio, and data viewer allows the user to view and playback all of the recorded data on a PC.

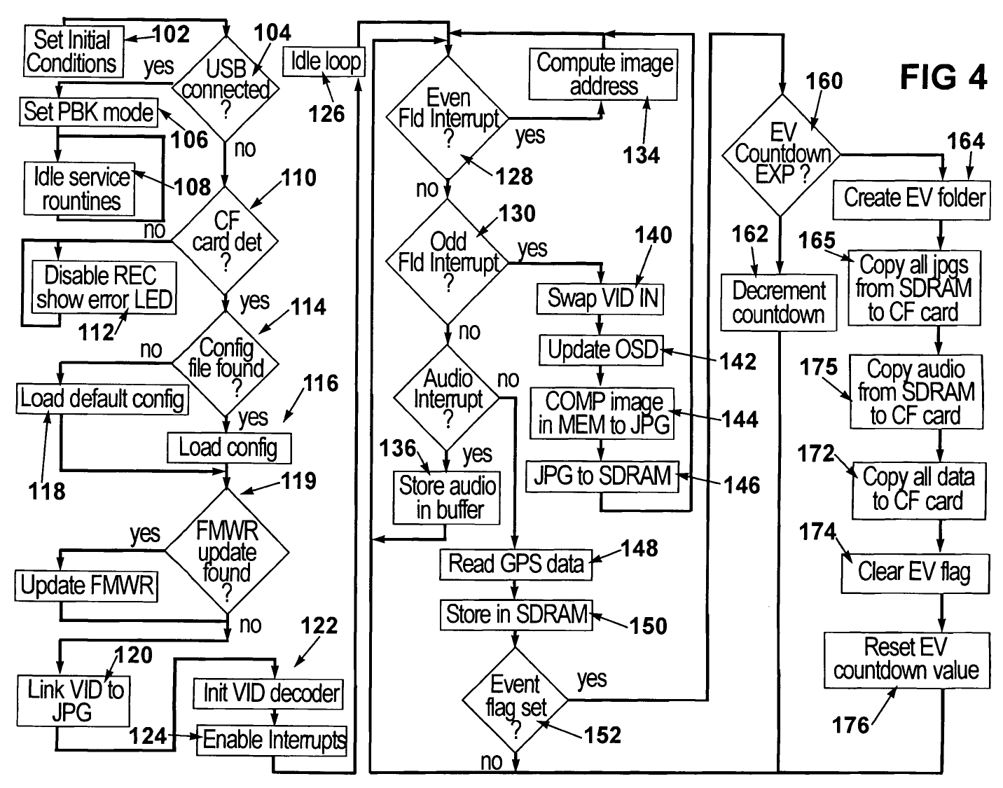

FIGS. 3 and 4 describe the algorithms used by the interactions of the two processors 16, 18, primary loop 100 and secondary loop 200. When the device 10 is initiated, the secondary processor 18 sends an instruction to reset the primary processor 210. Following the primary reset 210, the secondary processor software initializes ADC channels 212, initializes the GPS 214, sets initial conditions 214 according to the configuration file 80 and enables interrupts 218 and the master processor enters an idle loop 220. When a I²C command is received 222 a master service request is signaled 224. If no I²C request is present the VART receive buffer is queried for data 226. If GPS data is present 228, the data is stored in the buffer. If no GPS data is present, A request to get the voltage from the A to D Converter (ADC) is signaled 230. If the voltage is low (no condition) a power loss flag is set 234. The battery countdown is started 236 and an event flag is set 238. If the voltage from the ADC 230 is ok, the x axis G data is obtained from the ADC 240, followed by the y axis G data 242. The master processor now checks 244 for a power loss flag set 234. If a flag was set, the battery countdown starts a decrement 246. If the power loss flag was not set 244, the x or y G data is check for over limit 252. If the limit is exceeded, an event flag is set 256 which is signaled to the I²C. If the x or y G data is not over limit, the panic input is checked for activation 254. If an activation is present, an event flag is set 256. In the case of a power loss flag set 244, the battery countdown is started 246. When the countdown expires 248, the battery is turned off 250

When the primary processor 16 receives its initial conditions, it checks for USB connectivity at step 104 and for CF connectivity at step 110. If USB connectivity is detected, the device enters playback mode 106 and enters an idle service routine 108. If the long term memory compact flash 23 is not detected, recording is detailed and an error is displayed at step 112. The primary processor 16 then checks the nonvolatile memory 23 for the configuration file 80. If the configuration file 80 is not detected, the software will load the default configuration 118. If a user created configuration file is detected, it will be loaded at step 116. After the configuration file is loaded 116, the firmware file is checked 119. If a newer file is found on the card than that present in the device, the firmware is loaded and the device is automatically updated 119.

Once the hardware and software checks have been completed, the primary processor 16 links at step 120 with the hardware jpg codec 43 and the video decoder 42 is initialized at step 124. Interrupts are then enabled at step 124 and the idle loop 86 is entered at step 126.

During the idle loop 86, checks 128, 130 are performed for even 88 and odd 90 field interrupts. During an even field interrupt, the CPU 14 computes the address of the captured image at stepl 34. If no odd field interrupt has occurred, audio is stored in the volatile memory at step 136. If an odd field interrupt has occurred, video storage begins. The processor 14 sends a signal to swap video input channel 140, update 142 the OSD overlay 94, compress the captured image to a compressed format 144, and store the image in memory 146.

After an odd field interrupt, the primary processor 16 communicates with the secondary processor 148, checking for an event flag at step 152. If no event flag has been sent, the secondary data is stored at step 150 in the volatile memory 21 and the idle loop at step 86 is repeated.

The detection of an event flag triggers the transfer of data 154 to the long term non volatile flash memory 23 from the volatile short term RAM memory. When the primary processor receives an event flag from the secondary processor 18, the primary processor 16 first checks if the internal countdown, that specifies which data gets transferred to the long term, non volatile memory 23, has expired 160. Once the internal countdown expires, an event folder is created in the non volatile memory at step 164, of the image frames relating to the event are then transferred to the event folder 166. An AVI or ABI file is created 168 using the image frames and the audio samples and data samples are also copied 170, 172 to the event folder. The primary processor then clears the event flag 174, clears the countdown 176 reenters idle loop 86 and continues recording images to the volatile memory 21 in preparation of another designated event.

The operation of the device 10 will now be described below.

Under normal conditions, the device is turned on, or “actuated”, and turned off or “de-actuated”in connection with the vehicle in which it resides being turned on and off. As such, when the vehicle's ignition switch is in the off position, the device will normally be off.

The device however can include a switch that, in connection with a direct connection to an “always live” circuit of the car, or a battery back up, will enable the user to turn the device on and allow it to operate even in when the car is turned off. Also, as described below, the device is preferably designed to continue operation after the occurrence of a designated event, regardless of whether the car is running.

When the device is turned powered up, the cameras 22, 24 will capture images of whatever is in front of the lenses of the cameras. These images will first be recorded onto the short term memory, such as the RAM chip. The RAM chip will be used because the RAM typically provides faster storage capabilities than the flash card chip 23, although presumably, flash memories 23 chips can exist or may exist shortly, that are capable of capturing data as quickly as currently existing RAMs.

It is possible, although not necessarily required, that the RAM 21 from time to time, may download historical images into the longer term flash memory 23 for more permanent storage. For example, the user may choose to program the device to download an image or two at every time interval, or distance interval (e.g. every half mile, every 30 seconds) into the flash memory. These downloaded “historical” images would continue to be downloaded into the flash memory during the daily operation of the device, so that at the end of the device's “day” or “shift”, the fleet manager would have a record of what the vehicle did during that day of operation, regardless of whether any designated events occurred.

During those days when no designated event occurs, the device will continue to operate and capture images, so long as the device and the vehicle are turned on. When the vehicle is shut down (turned off) the camera and the components within the housing, such as the timer, accelerometer, flash memory 23, CPU 14, RAM 21 and signal light will be turned off. If the RAM 21 and flash memory 23 may or may not be erased.

However, the device operates differently during those times when a designated event occurs.

The type of designated event that is likely to cause the device to operate differently is an event such as a crash, or some other event designated by the user/fleet manager. Such events could include such things as a signal from the GPS within the vehicle that signals that the vehicle is outside of a defined territory in which the vehicle is designated to operate or if the vehicle exceeds a pre-set speed parameter. Additionally, a designated event could comprise an actuation by the user, such as when the user might press a panic button in the event of a robbery.

Short term volatile memory, such as RAMs, are generally capable of only holding a finite amount of data. This finite amount of data may comprise as little as a few seconds worth of data, but may comprise substantially more, depending upon the size of the RAM. Typically, a RAM might be used in the device that is designed to capture between 20 to 40 seconds worth of data. A user designation can preserve certain tagged events such as a high G crash) to not be overwritten.

During operation, data will be first “written” onto the RAM. However, a point will be reached where the RAM is full. At this point, older images are overwritten by newly acquired images. A wide variety of overwriting schemes exist which can be employed in connection with the present invention. For example, the RAM can be segmented into a plurality of segments, each of which is capable of holding thirty seconds of video data. The RAM 21 may include four or more of these thirty-second segments. The multiple segments could then be overwritten in a random order, without regard to which segment contained the earliest acquired data. However, such segmenting does have draw backs as it adds to the expense of the device.

It will also be appreciated that the amount of data that can be captured in a RAM, will be governed by things such as user preference, image size, and of course, the size of the RAM. In the event that a designated event, such as a crash occurs, the device will operate differently. Similar to its normal operation, the cameras will continue to capture images both before and after the designated event occurs. The images so captured by the cameras will be deposited on the RAM as discussed above.

When a crash occurs, the event detector, such as the accelerometer, can detect the presence of a designated event, such as a crash. This detection of a designated event will cause a signal to be sent to the RAM to begin downloading pictures onto the longer term flash memory. In this case, the RAM will serve as a buffer, downloading whatever images are then stored on the RAM, in addition to temporarily storing and downloading whatever later images are captured by the cameras after the designated event occurs. Alternately, the images can be written directly to the flash memory.

Images will continue to be captured by the camera, deposited upon the RAM 21 temporarily, and then transferred to flash memory 23, until such time as the flash memory 23 is full. Since the flash memory 23 may contain a variable amount of data at the time when a designated event occurs, the time period during which this continuous capture of data occurs is likely to vary significantly from event to event, depending, once again, on how full the flash memory 23 is when the designated event occurs.

Even when the flash memory is full, the camera will continue to capture images, and to deposit these images on the short term RAM memory. As such, images will continue to be captured until the user stops the capture of images by hitting a reset button (if the unit contains a reset button) or otherwise, the device is turned off.

Additionally, in devices that include an optional, user actuable reset button, a timer is actuated when the event detector detects a designated event. The timer is actuated to keep the device running, an in particular, to signal the computer to continue its operation for a minimum period of time (e.g. 45 seconds) after the event is detected. As such, if the user hits the reset or on-off button five seconds after the event detector detects a designated event, and if the timer is set for 45 seconds, the cameras will continue to capture images for the 45 second period governed by the timer, regardless of the user's desire to shut off the camera by hitting the reset or on-off switch. Of course, the images so captured will be downloaded onto the RAM 21 or other short term, volatile, interim memory, and then ultimately deposited onto the flash memory 23.

However, if the user does not actuate the optional reset button within this “timer delay” period, the camera will continue to capture images and download them onto the RAM, until the user either actuates the reset button, or the device 10 is shut off through the operation of the vehicle. Additionally, images that are downloaded onto the RAM 21 will be downloaded onto the flash memory 23 until such time as the flash memory 23 is full.

A signaling device, such as an audio speaker, flashing light, LED or other audio or visual warning device may be included as part of the device, which can be actuated to alert the user as to the continuous capture of images by the cameras. Depending upon the user's preference, the warning/speaker/signaling device could be actuated to begin chirping or flashing immediately upon a designated event occurring. Alternately, the warning/signaling device could be set to set off a signal at some time period after the designated event occurs. For example, the device could be designed to cause an audio speaker-type signaling device to begin chirping and flashing after the expiration of the timer delay period to thereby signal to the user that the reset button could be actuated, or alternately, signaling to the user that it was appropriate to shut the device down.

In summary, one important difference between the Applicant's instant invention and some prior art discussed above is the existence of a triggering event, or designated event does not stop the capture of data by the cameras, or the writing of data on the RAM. Rather, the capturing of data continues to occur for some time, until either the device is full, or the user shuts the device off.

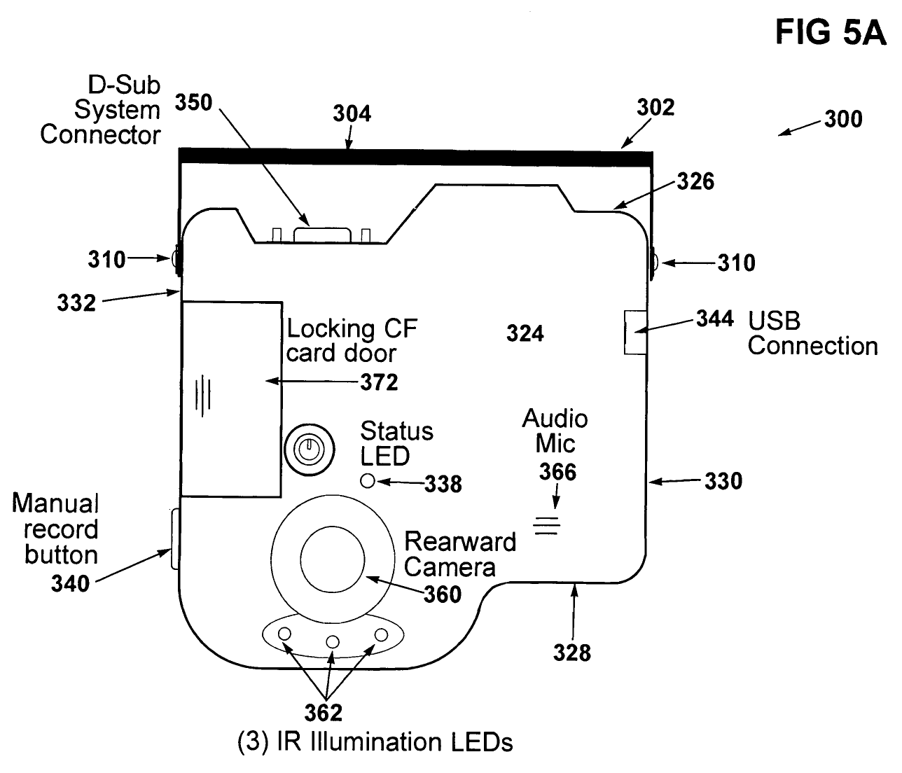

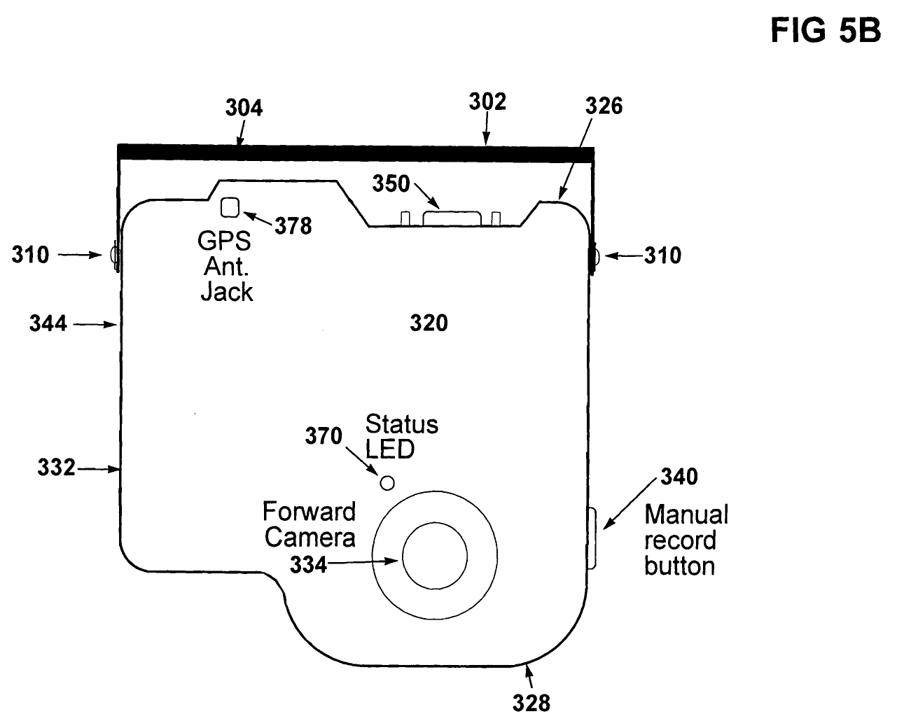

Turning now to FIGS. 5A and 5B, exterior views of the device 300 are shown. The device 300 includes a housing 301 that is preferably made of a plastic or metal material, and is sized and shaped to contain all of the primary components of the device, such as the components described in connection with the discussions of FIGS. 1A and 1B. The housing 301 is coupled to a mounting assembly 302 that is adjustable for leveling the view of the device. The mounting assembly 302 serves to mount the housing 301 onto a fixed component of a vehicle, such as a windshield or dashboard (not shown). The mounting assembly 302 shown in the drawings is designed to couple the housing 301 to a windshield of a car.

In this regard, FIG. 5A shows a rearwardly facing surface 324 of the housing that one would view if one were sitting in the front seat of the car and looking out the windshield. By contrast, FIG. 5B shows a view of the forwardly facing surface 320 of the housing that one would see if one were standing in front of the car and looking through the windshield into the interior of the car.

The first mounting member 304 is preferably fixedly coupled to an interior surface of the windshield. The mount 304 can be mounted to the windshield with torque bolts, or else with a very strong adhesive or double stick-type tape. The mount 304 engages security hardware, which preferably comprise Torx screws 310 to fixedly, but removably couple the case 301 to the mount.

The housing 301 includes a forwardly facing surface 320 (FIG. 5B), a rearwardly facing surface 324 (FIG. 5A), an upper surface 326 that is coupled to the mounting member 302, a lower surface 328, a first side surface 330, and a second side surface 332. The forwardly facing surface 320 includes a camera lens opening 334, behind which is a camera lens and camera (e.g. 22 or 24). Because of its positioning on the forwardly facing surface 320, the camera behind the camera lens opening 334 will be positioned for capturing images through the windshield of the vehicle, of objects that are disposed in front of the vehicle. For example, while driving in traffic, the images taken through the camera that is behind camera lens opening 334 would likely be images of the car in front of the vehicle in which the recording device 300 resides.

Additionally, a microphone hole 366 and a status LED 338 are also disposed on the forward facing surface 320. A user actuable manual record button 340 is disposed on the second side surface 332. The manual record button 340 can be actuated by the user to manually actuate the device 300 to begin storing images recorded by the cameras 22, 24, 27 onto the flash memory for long term storage.

The user may decide to manually actuate and begin this storage if something occurs that the user wishes to record, but that does not entail a designated event. For example, if the device is used in a cab, the driver may wish to manually actuate the record button to record a suspicious passenger in the cab, so that if the suspicious cab passenger should turn out to commit a crime (such as robbing the cabbie), the device would record its image of the suspicious person/robber to thereby aid in the apprehension and conviction of the criminal.

A USB port 344 can be disposed on the first side surface 330. The USB port 344 can comprise the USB port 38 shown in FIGS. 1A and 1B, that provides the port into which a flash device 49, third camera 37, or wireless transmitter 41 can be plugged into to transfer data between the device and the attached accessory.

A power plug/signal port jack 350 can be provided on the second side surface for receiving a power harness (not shown). The power harness can comprise a harness that contains a plurality of wires. One of the wires can be provided for providing operating power for the device 300. Others of the wires and lines within the power harness can be provided for conveying signals to and from the device. The power harness (not shown) is detachable and in the preferred embodiment is secured to the case 301 with security hardware.

A camera lens opening 360 can also be disposed on the rearwardly facing surface 324 of the device. A camera can be placed behind the camera hole 360, similar to the camera discussed in connection with the forwardly facing camera hole 334. However, a camera placed behind camera hole 360 would be provided for taking images that would be directed rearwardly, such as either behind the vehicle, or within the interior of the car. In the hypothetical discussed above relating to the suspicious person who is riding in the cab, the camera is placed behind camera hole 360, would be the camera that would most likely pick up images of the suspicious person sitting in the back seat of the cab, since the camera contained within hole 360 has its lens pointed in a rearwardly direction.

Three infra-red LEDs 362 are also placed on the rearwardly facing surface. A speaker microphone hole 366 is also provided in the casing 366, along with a status LED 370. The status LED 370 provides information about the status of the device, such as whether the device is operating or not. A GPS antenna jack 378 is provided on the forward facing surface 320 for an external GPS antenna.

A locking door 372 is also provided in a rearwardly facing surface of the housing 301. The locking door 372 is provided for covering a flash card compartment (not shown). The flash card compartment contains a receptacle for holding a flash card. As alluded to above, the flash card (23 in FIGS. 1A and 1B) can comprise a currently manufactured CF card, SD card, SDHC card, XD card, memory stick or some sort of other flash memory, or other type of memory storage device that is known now, or that may be invented in the future.

Further embodiments other than those that are described herein exist that will be apparent to those skilled in the art. Alternative circuitry, mounting, or playbacks are all possible, along with a different software algorithm. Therefore, this invention is limited only by the appended claims, which include all such other embodiments and modifications when viewed in conjunction with the above specification and accompanying drawings.

What is claimed:

1. A video recording device capable of being mounted in a vehicle for recording images incident to the operation of a vehicle, the vehicle recording device comprising:
a housing mountable to a vehicle component,
at least one image sensor for capturing images,
a processor coupled to the housing and in communication with the image sensor for processing images captured by the image sensor,
an event detector for detecting the existence of a designated event, and
a long term memory device for storing images captured by the at least one image sensor for a time period prior to, and for a time period following the detection of a designated event by the event detector.

2. The video recording device of claim 1 wherein the image sensor comprises a first and a second independently controllable image sensor, both of the first and second image sensors being coupled to the housing.

3. The video recording device of claim 1 further comprising a receiver for receiving images from a third image sensor disposed remotely of the housing.

4. The video recording device of claim 3 wherein the receiver comprises at least one of a wireless receiver and a wired USB Port.

5. The video recording device of claim 1 wherein at least one of the first and second image sensors is adjustably positionable for capturing images interiorly of the vehicle and exteriorly of the vehicle.

6. The video recording device of claim 1 wherein the processor includes a video decorder for converting analog signals captured by the image sensors to digital signals.

7. The video recording device of claim 1 wherein the processor is capable of processing images captured by the image sensor to compress the size of the images.

8. The video recording device of claim 1 further comprising a short term memory device capable of storing images at a faster rate than the long term memory device, the short term memory device being capable of storing a limited amount of images, wherein said stored images can be overwritten by later acquired images.

9. The video recording device of claim 8, wherein the short term memory is capable of storing images taken from at least fifteen seconds immediately prior to the time of overwriting.

10. The video recording device of claim 1, further comprising a short term memory device capable of storing images at a faster rate than the long term memory device, wherein the detection of a designated event by the event detector causes images stored on the short term memory device to be transferred to the long term memory device, and the image sensor to capture to continue capturing images, for ultimate placement on the long term memory device.

11. The video recording device of claim 12 wherein images captured by the image sensor will continue to be transferred to the long term memory for an indeterminate period of time until the long term memory has reached a designated capacity state.

12. The video recording device of claim 10 wherein images captured by the image sensor after the detection of a designated event will be processed and compressed by the processor, transferred to the short term memory device that shall serve as a buffer for the long term memory device, the images stored on the short term memory device being transferred to the long term memory device.

13. The video recording device of claim 1 further comprising a date port, and an external memory driver capable of being coupled to the data port for receiving data from the long term memory device, and storing said data, the external memory drive being capable of being coupled to a computer for permitting the user to upload data stored on the external memory device to the computer.

14. The video recording device of claim 13 wherein the external memory device comprises a flash memory drive.

15. A video recording device capable of being mounted in a vehicle for recording images incident to the operation of the vehicle,
a housing mountable to a vehicle,
a first and a second image sensor, both of the first and the second image sensors being coupled to the housing,
a processor coupled to the housing and in communication with the image sensor for processing image captured by the image sensor, the processing including compressing the size of the image, an event detectable for detecting the existence of a designated event,
a long term memory device for storing images captured by the first and second image sensors for a time period prior to and for a time period following the detection of a designated event by the event detector,
a short term memory device capable of storing images at a faster rate than the long term memory device, the short term memory device being capable of storing a limited amount of images, and wherein said stored images can be overwritten by later acquired images, and
a receiver for receiving data from a data generator disposed remotely of the housing.

16. The video recording device of claim 15 wherein the data generator comprises at least one of a geographic location device, a third image sensor, an audio device and user actuable data input device.

17. The video recording device of claim 16 further comprising a user actuable data acquisition terminator for permitting the user to terminate at least one of the capture and storage of images, and a timer for preventing the termination of the at least one of the capture and storage of images for a predetermined time after the occurrence of a designated event.

18. The video recording device of claim 17 further comprising a user actuable switch for commencing the transfer of data acquired prior to, and subsequently of the actuation of the user actuable switch from the short term memory device to the long term memory device.

19. The video recording device of claim 15 further comprising a data storage device capable of retrieving data from the video recording device, and transferring same to a remote computer for play back.
